(19) United States
(12) Patent Application Publication
(10) Pub. No.: US 2024/0019040 A1
(43) Pub. Date: Jan. 18, 2024

(54) PIEZOELECTRIC VALVE

(71) Applicants: SATAKE CORPORATION, Chiyoda-ku, Tokyo (JP); MECHANO TRANSFORMER CORPORATION, Chiyoda-ku, Tokyo (JP)

(72) Inventors: Takafumi ITO, Chiyoda-ku, Tokyo (JP); Sze Keat CHEE, Chiyoda-ku, Tokyo (JP)

(73) Assignees: SATAKE CORPORATION, Chiyoda-ku, Tokyo (JP); MECHANO TRANSFORMER CORPORATION, Chiyoda-ku, Tokyo (JP)

(21) Appl. No.: 18/039,340

(22) PCT Filed: Nov. 30, 2021
(86) PCT No.: PCT/JP2021/043869

§ 371 Date: May 30, 2023

(30) Foreign Application Priority Data
Dec. 1, 2020 (JP) 2020-199582

(51) Int. Cl. F16K 31/00; F16K 27/00

(52) U.S. Cl. CPC F16K 31/004; F16K 27/003

(57) ABSTRACT

A piezoelectric valve including actuators that are respectively adapted to drive valve elements, and a valve body including a gas inlet port, and a plurality of gas outlet ports, the piezoelectric valve is attachable to and detachable from a fluid device via a connector unit including an inlet passage that is communicable at one end with the gas inlet port, and is communicable at another end with an air supply passage of the fluid device, and a plurality of discharge passages that are respectively communicable at one end with the plurality of gas outlet ports, and are respectively communicable at another end with a plurality of gas outlet passages of the fluid device, and a pitch of openings of the plurality of discharge passages on the other end side is greater than a pitch of openings of the plurality of discharge passages on the one end side.

### TECHNICAL FIELD

The present invention relates to a piezoelectric valve that opens and closes a valve using a displacement of a piezoelectric element.

### BACKGROUND ART

Conventionally, a piezoelectric valve that opens and closes a valve using a displacement of a piezoelectric element to eject compressed gas is well-known (see Patent Literatures 1 to 3).

The piezoelectric valve uses the characteristics of a piezoelectric element having excellent high-speed responsiveness, and includes an actuator adapted to perform an operation of opening and closing a valve element using a displacement of the piezoelectric element.

The piezoelectric valve disclosed in each of Patent Literatures 2 and 3 is configured such that a plurality of actuators that are respectively adapted to drive a plurality of valve elements individually are housed within a valve body, and the plurality of valve elements are respectively driven to be open by the plurality of actuators so that compressed gas supplied into the valve body is individually discharged through a plurality of gas outlet ports provided in a front face of the valve body. Such a piezoelectric valve can be used by being attached to a fluid device.

Patent Literature 3 discloses an example in which the piezoelectric valve is used for an ejector of an optical sorter, and the ejector includes a manifold to be supplied with compressed air from a compressed air source, a nozzle member including a plurality of nozzle holes communicating with a plurality of gas outlet passages formed in the manifold, and a plurality of piezoelectric valves attached to the manifold via a connector unit in a continuous manner.

By the way, the ejector disclosed in Patent Literature 3 is based on the premise that the pitch of the plurality of nozzle holes, that is, the pitch of the plurality of gas outlet passages formed in the manifold is the same as the pitch of the plurality of gas outlet ports provided in the front face of the valve body of the piezoelectric valve.

Therefore, if the pitch of the plurality of gas outlet passages formed in the manifold is different from the pitch of the plurality of gas outlet ports provided in the front face of the valve body of the piezoelectric valve, the piezoelectric valve may not be able to be used by being attached to the manifold.

### CITATION LIST

### Patent Literature

### [Patent Literature 1]

Japanese Patent Laid-Open No. 2004-316835

### [Patent Literature 2]

Japanese Patent Laid-Open No. 2013-124695

### [Patent Literature 3]

Japanese Patent Laid-Open No. 2015-137664

### SUMMARY OF INVENTION

### Technical Problem

Accordingly, an object of the present invention is to provide a piezoelectric valve that can be used by being attached to a fluid device even when the pitch of a plurality of gas outlet ports provided in a front face of a valve body is smaller than the pitch of a plurality of gas outlet passages formed in the fluid device.

### Solution to Problem

To achieve the foregoing object, an embodiment of the present invention provides a piezoelectric valve including: a plurality of actuators that are respectively adapted to drive a plurality of valve elements individually in parallel planes using displacements of piezoelectric elements; and a valve body that houses the plurality of actuators, in which a front face of the valve body includes a gas inlet port adapted to suck compressed gas into the valve body, and a plurality of gas outlet ports adapted to discharge the compressed gas that has been sucked into the valve body through the gas inlet port as the plurality of valve elements are driven to be open, the piezoelectric valve is attachable to and detachable from a fluid device via a connector unit provided on the front face of the valve body, the connector unit includes an inlet passage that is communicable at one end with the gas inlet port, and is communicable at another end with an air supply passage formed in the fluid device, and a plurality of discharge passages that are respectively communicable at one end with the plurality of gas outlet ports, and are respectively communicable at another end with a plurality of gas outlet passages formed in the fluid device, and a pitch of openings of the plurality of discharge passages on the other end side is greater than a pitch of openings of the plurality of discharge passages on the one end side.

In an embodiment of the present invention, the piezoelectric valve further preferably includes a valve seat plate adapted to have the plurality of actuators fixed thereto, the valve seat plate including a plurality of valve seats and a plurality of discharge passages, the plurality of valve seats being respectively adapted to be positioned in contact with and away from the plurality of valve elements individually, in which the plurality of actuators are preferably housed within the valve body together with the valve seat plate, and the compressed gas that has been sucked into the valve body through the gas inlet port is preferably discharged from each of the plurality of gas outlet ports individually via the plurality of discharge passages of the valve seat plate as the plurality of valve elements respectively move away from the plurality of valve seats.

The plurality of gas outlet ports may be openings at the distal end side of the plurality of discharge passages of the valve seat plate.

The fluid device is preferably a manifold, and compressed gas supplied from a compressed gas source is preferably supplied into the valve body from the air supply passage via the inlet passage of the connector unit, and compressed gas discharged from the valve body is preferably discharged from the plurality of gas outlet passages via the plurality of discharge passages of the connector unit.

The manifold preferably includes nozzle holes at the respective distal ends of the plurality of gas outlet passages, and compressed gas discharged from the valve body is preferably discharged from the plurality of gas outlet passages via the plurality of discharge passages of the connector unit and then ejected from the respective nozzle holes.

### Advantageous Effects of Invention

In the piezoelectric valve of the present embodiment, the connector unit includes an inlet passage that is communicable at one end with the gas inlet port provided in the front face of the valve body, and is communicable at another end with the air supply passage formed in the fluid device, and a plurality of discharge passages that are respectively communicable at one end with the plurality of gas outlet ports provided in the front face of the valve body, and are respectively communicable at another end with the plurality of gas outlet passages formed in the fluid device, and the pitch of openings of the plurality of discharge passages on the other end side is greater than the pitch of openings of the plurality of discharge passages on the one end side. Thus, even when the pitch of the plurality of gas outlet ports provided in the front face of the valve body is smaller than the pitch of the plurality of gas outlet passages formed in the fluid device, it is possible to use the piezoelectric valve by attaching it to the fluid device by selecting an appropriate connector unit provided on the front face of the valve body.

In the piezoelectric valve of the present embodiment, the fluid device is a manifold, and compressed gas supplied from a compressed gas source is supplied into the valve body from the air supply passage via the inlet passage of the connector unit, and compressed gas discharged from the valve body is discharged from the plurality of gas outlet passages via the plurality of discharge passages of the connector unit, whereby the piezoelectric valve can be used for an ejector of an optical sorter, for example, by being attached to the manifold.

### BRIEF DESCRIPTION OF DRAWINGS

FIG. 1 is a perspective view of a piezoelectric valve.

FIG. 2 is an exploded view of the piezoelectric valve.

FIG. 3 is an illustration view of actuators.

FIG. 4 is an illustration view of a state in which the actuators are fixed to a valve seat plate.

FIG. 5 is a side cross-sectional view of the piezoelectric valve, illustrating a state in which the valve seat plate is arranged in a valve body.

FIG. 6 is an illustration view of an ejector as seen from its front face side.

FIG. 7 is a cross-sectional view along line F-F in FIG. 6.

FIG. 8 is a schematic illustration view of a conventional ejector as seen from its front face side.

FIG. 9 is a schematic illustration view of an ejector of an embodiment of the present invention as seen from its front face side.

### DESCRIPTION OF EMBODIMENTS

An embodiment of the present invention will be described with reference to the drawings.

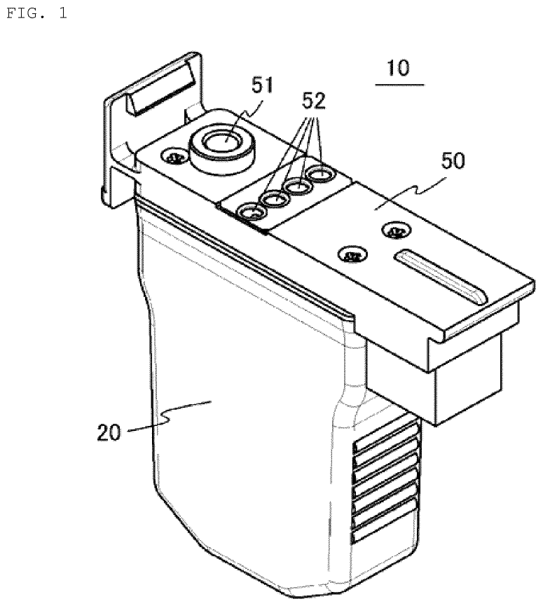

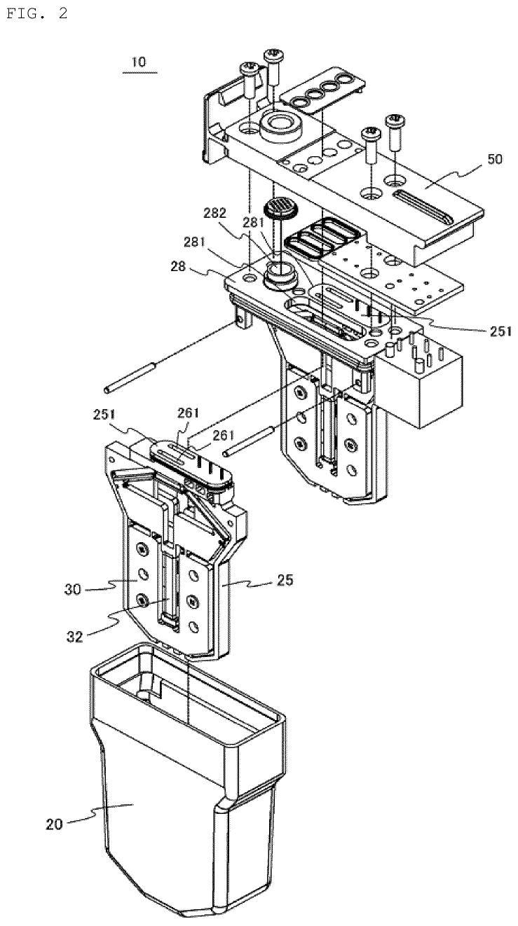

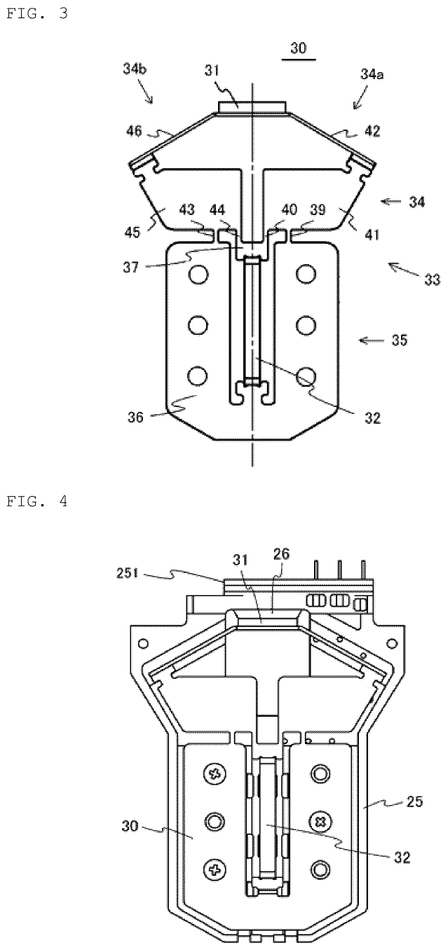

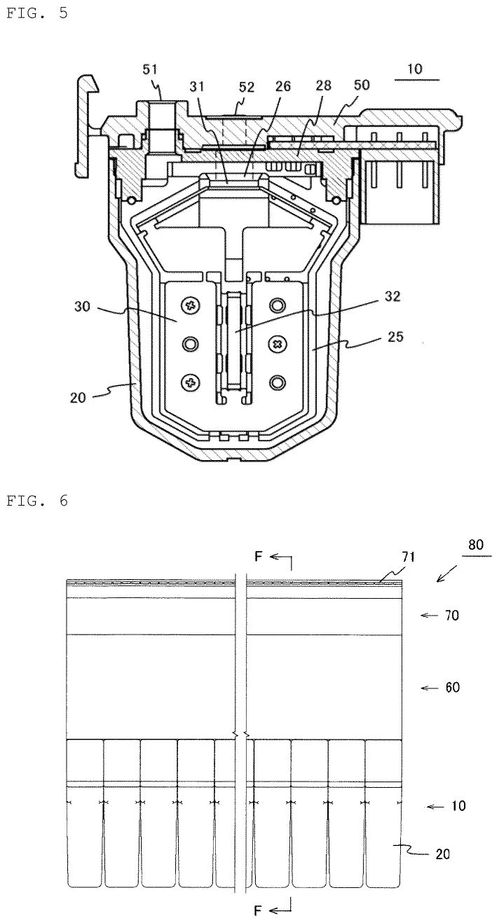

FIG. 1 is a perspective view of an exemplary piezoelectric valve. FIG. 2 is an exploded view of the piezoelectric valve in FIG. 1. FIG. 3 is an illustration view of actuators used for the piezoelectric valve in FIG. 1. FIG. 4 is an illustration view of a state in which the actuators are fixed to a valve seat plate used for the piezoelectric valve in FIG. 1. FIG. 5 is a side cross-sectional view of the piezoelectric valve in FIG. 1, illustrating a state in which the valve seat plate is arranged in a valve body.

A piezoelectric valve 10 illustrated in FIGS. 1 to 5 includes a valve body 20, a valve seat plate 25 arranged in and fixed to the valve body 20, and actuators 30 fixed to opposite faces of the valve seat plate 25 with screws.

The valve body 20 is a case having an open front face, and includes an internal gas pressure chamber to be supplied with compressed gas from an external compressed gas supply source (not illustrated).

A connector unit 50 is attached to the front face of the valve body 20 with screws. The front face of the connector unit 50 is provided with an inlet port 51 for sucking compressed gas into the valve body 20, and a plurality of outlet ports 52 for discharging the compressed gas.

Described herein is an example in which the front face of the connector unit 50 is provided with four outlet ports 52.

The valve seat plate 25 has on its opposite faces attachment portions for the actuators 30, and has a valve seat 26 that is adapted to be contacted by a valve element 31, which is described below, of each actuator 30. In addition, a front protrusion 251 of the valve seat plate 25 has formed therein a plurality of gas discharge passages 261 communicating with the outlet ports 52 of the connector unit 50 from a valve seat face of the valve seat 26.

The front face of the valve seat plate 25 has attached thereto a cover member 28 that closes the opening of the valve body 20. The cover member 28 has formed therein openings 281 in which the front protrusion 251 of the valve seat plate 25 is adapted to fit. The cover member 28 also has formed therein a gas inlet passage 282 communicating with the inside of the valve body 20 from the inlet port 51 of the connector unit 50.

Herein, the cover member 28 may have, instead of having the openings 281 formed therein, openings for discharging gas formed therein so as to allow the distal end face of the front protrusion 251 of the valve seat plate 25 to abut the cover member 28 and thus allow the plurality of gas discharge passages 261 to communicate with the openings for discharging gas.

Each actuator 30 includes, as illustrated in FIG. 3, a valve element 31, a piezoelectric element 32 adapted to generate as a displacement a drive force needed to operate the valve element 31, and a displacement magnification mechanism 33 adapted to magnify the displacement of the piezoelectric element 32 and allow the magnified displacement to act on the valve element 31.

The displacement magnification mechanism 33 includes a displacement magnification portion 34 adapted to magnify the displacement of the piezoelectric element 32, and a displacement transmission portion 35 adapted to transmit the displacement of the piezoelectric element 32 to the displacement magnification portion 34. The displacement magnification mechanism 33 is disposed symmetrically about the axis of the valve element 31 in the operation direction, specifically, a straight line connecting the longitudinal axes of the valve element 31 and the piezoelectric element 32.

The displacement transmission portion 35 includes a U-shaped base substrate 36 to which one end of the piezoelectric element 32 is joined, and a cap member 37 to which the other end of the piezoelectric element 32 is joined. As the piezoelectric element 32 is arranged in the space of the U-shaped base substrate 36, the displacement magnification mechanism 33 is disposed symmetrically about the longitudinal axis of the piezoelectric element 32.

The displacement magnification portion 34 includes first and second displacement magnification portions 34a and 34b that are disposed symmetrically about the straight line connecting the longitudinal axes of the valve element 31 and the piezoelectric element 32.

The first displacement magnification portion 34a includes first and second hinges 39 and 40, a first arm 41, and a first leaf spring 42. The first arm 41 is integrated with the distal end of the U-shaped base substrate 36 on one side by means of the first hinge 39, and is integrated with the cap member 37 by means of the second hinge 40. The distal end portion of the first arm 41 on the outer side has one end of the first leaf spring 42 joined thereto.

Meanwhile, the second displacement magnification portion 34b includes third and fourth hinges 43 and 44, a second arm 45, and a second leaf spring 46. The second arm 45 is integrated with the distal end of the U-shaped base substrate 36 on the other side by means of the third hinge 43, and is integrated with the cap member 37 by means of the fourth hinge 44. The distal end portion of the second arm 45 on the outer side has one end of the second leaf spring 46 joined thereto.

Herein, the displacement magnification mechanism 33 can be integrally formed by stamping a metallic material, such as a stainless steel material including an invar material, except the first and second leaf springs 42 and 46, for example.

In addition, the first leaf spring 42 and the second leaf spring 46 can be formed from a single metal plate, for example. One ends of the first and second leaf springs 42 and 46 are joined to the respective distal end portions of the first and second arms 41 and 45 on the outer side. The valve element 31 is provided in an arrangement portion located between the other ends of the first and second leaf springs 42 and 46 and on the longitudinal axis of the piezoelectric element 32.

When a current is passed through the piezoelectric element 32 of the actuator 30 in the closed-valve state, the piezoelectric element 32 stretches. The displacement along with the stretching of the piezoelectric element 32 is magnified by the displacement magnification mechanism 33 based on the principle of leverage, specifically, with the first and third hinges 39 and 43 functioning as the fulcrums, the second and fourth hinges 40 and 44 functioning as the points of effort, and the distal end portions of the first and second arms 41 and 45 on the outer side functioning as the points of load. Thus, the distal end portions of the first and second arms 41 and 45 on the outer side are displaced to a large degree.

The displacement of the distal end portions of the first and second arms 41 and 45 on the outer side allows the valve element 31 to be positioned away from the valve seat 26 via the first and second leaf springs 42 and 46 so that the gas discharge passages 261 are opened.

Meanwhile, when the supply of a current to the piezoelectric element 32 of the actuator 30 is stopped, the piezoelectric element 32 shrinks, causing the valve element 31 to be seated on the valve seat 26 via the displacement magnification mechanism 33 so that the gas discharge passages 261 are closed.

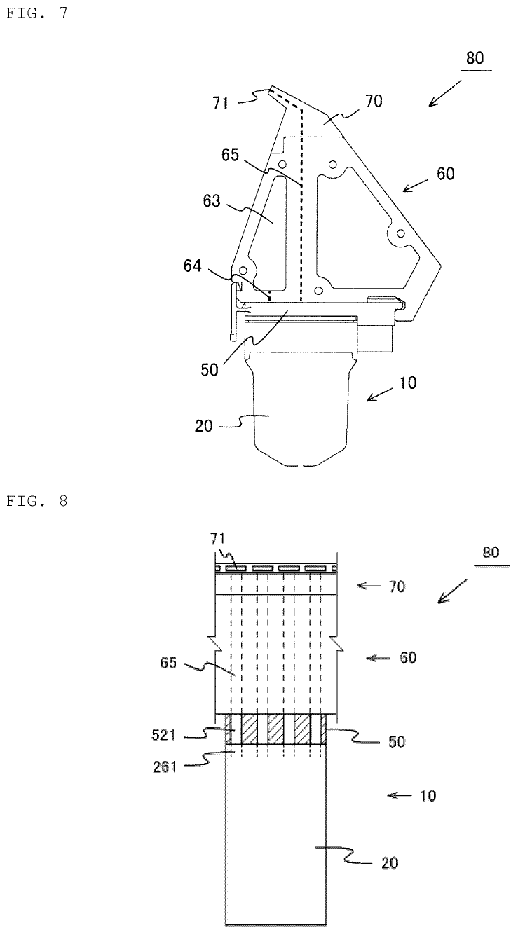

FIGS. 6 and 7 are illustration views of an ejector of an optical sorter. FIG. 6 is an illustration view of the ejector as seen from its front face side. FIG. 7 is a cross-sectional view along line F-F in FIG. 6, illustrating the ejector as seen from its side face side.

An ejector 80 illustrated in FIGS. 6 and 7 includes a manifold 60 having an internal air space 63 to be supplied with compressed air from a compressed air supply source (not illustrated), the piezoelectric valve 10 attached to the manifold 60 via the connector unit 50, and a nozzle member 70 attached to the manifold 60.

The manifold 60 includes a large number of air supply passages 64 and a large number of gas outlet passages 65, each communicating with the air space 63, in the longitudinal direction. Nozzle holes 71 of the nozzle member 70 are respectively provided in communication with the large number of gas outlet passages 65.

The piezoelectric valve 10 is attached to the manifold 60. The inlet port 51 of the connector unit 50 communicates with the air supply passages 64 of the manifold 60. The plurality of outlet ports 52 of the connector unit 50 communicate with the plurality of gas outlet passages 65 of the manifold 60.

The manifold 60 has formed therein, based on one air supply passage 64 and four gas outlet passages 65 as a unit, as many units as the piezoelectric valves 10 attached to the manifold 60 along the longitudinal direction.

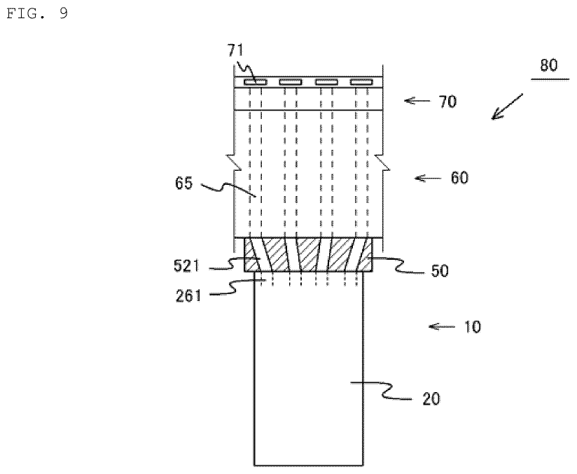

FIG. 8 is a schematic illustration view of a conventional ejector as seen from its front face side, which schematically illustrates the relationship between flow passages in a manifold and a piezoelectric valve (and schematically illustrates a cross-section of a connector unit of the piezoelectric valve).

The connector unit 50 of the piezoelectric valve 10 has formed therein a plurality of discharge passages 521 communicating at one end with the plurality of gas discharge passages 261 that are open at the front face of the valve body 20 and communicating at the other end with the plurality of gas outlet passages 65 formed in the manifold 60.

As illustrated in FIG. 8, the conventional ejector 80 is based on the premise that the pitch of the plurality of gas discharge passages 261 that are open at the front face of the valve body 20 of the piezoelectric valve 10 and the pitch of the plurality of discharge passages 521 formed in the connector unit 50, and the pitch of the plurality of nozzle holes 71 of the nozzle member 70 and the pitch of the plurality of gas outlet passages 65 formed in the manifold 60 are the same.

Therefore, when the pitch of the plurality of gas outlet passages 65 formed in the manifold 60 is different from the pitch of the plurality of gas discharge passages 261 that are open at the front face of the valve body 20 of the piezoelectric valve 10, the piezoelectric valve 10 cannot be used by being attached to the manifold 60, which is problematic.

FIG. 9 is a schematic illustration view of an ejector of an embodiment of the present invention as seen from its front face side, which schematically illustrates the relationship between flow passages in a manifold and a piezoelectric valve (and schematically illustrates a cross-section of a connector unit of the piezoelectric valve).

As illustrated in FIG. 9, in the ejector 80 of the embodiment of the present invention, the pitch of openings of the plurality of discharge passages 521 formed in the connector unit 50 on a side communicating with the plurality of gas outlet passages 65 formed in the manifold 60 is greater than the pitch of openings of the plurality of discharge passages 521 on a side communicating with the plurality of gas discharge passages 261 that are open at the front face of the valve body 20.

Consequently, even when the pitch of the plurality of gas discharge passages 261 that are open at the front face of the valve body 20 is smaller than the pitch of the plurality of gas outlet passages 65 formed in the manifold 60, the piezoelectric valve 10 can be used by being attached to the manifold 60.

According to the piezoelectric valve 10 of the embodiment of the present invention, there is no need to prepare a dedicated component for each pitch of the plurality of gas outlet passages 65 formed in the manifold 60, and even when the pitch of the plurality of gas discharge passages 261 that are open at the front face of the valve body 20 is smaller than the pitch of the plurality of gas outlet passages 65 formed in the manifold 60, it is possible to use the piezoelectric valve 10 by attaching it to the manifold 60 by selecting an appropriate connector unit 50.

Although the foregoing embodiment of the present invention has exemplarily illustrated the piezoelectric valve 10 in which four actuators 30 are arranged in the case of the valve body 20, and four gas discharge passages 261 are open at the front face of the valve body 20, the present invention is not limited thereto. It is acceptable as long as two or more actuators are arranged in the case of the valve body, and two or more gas discharge passages 261 are open at the front face of the valve body 20.

Although the foregoing embodiment of the present invention has exemplarily illustrated the piezoelectric valve 10 that includes the valve seat plate 25 adapted to have the actuators 30 fixed thereto and in which the actuators 30 are housed within the valve body 20 together with the valve seat plate 25, the present invention is not limited thereto. For example, the actuators can be directly housed within the valve body without the use of the valve seat plate.

In the piezoelectric valve of the embodiment of the present invention, each actuator is not limited to that of the embodiment as long as it drives the valve element using a displacement of the piezoelectric element.

Although the embodiment of the present invention has been described above, the present invention is not limited thereto, and the configuration of the present invention can be changed as appropriate without departing from the scope of the invention.

### INDUSTRIAL APPLICABILITY

The piezoelectric valve of the present invention can be used by being attached to a fluid device even when the pitch of a plurality of gas outlet ports provided in a front face of a valve body is smaller than the pitch of a plurality of gas outlet passages formed in the fluid device, and thus is quite useful.

### REFERENCE SIGNS LIST

10 Piezoelectric valve
20 Valve body
25 Valve seat plate
251 Front protrusion
26 Valve seat
261 Gas discharge passage
28 Cover member
281 Opening
282 Gas inlet passage
30 Actuator
31 Valve element
32 Piezoelectric element
33 Displacement magnification mechanism
34 Displacement magnification portion
35 Displacement transmission portion
36 Base substrate
37 Cap member
39 First hinge
40 Second hinge
41 First arm
42 First leaf spring
43 Third hinge
44 Fourth hinge
45 Second arm
46 Second leaf spring
50 Connector unit
51 Inlet port
52 Outlet port
521 Discharge passage
60 Fluid device (manifold)
63 Air space
64 Air supply passage
65 Gas outlet passage
70 Nozzle member
71 Nozzle hole
80 Ejector

1. A piezoelectric valve comprising:
a plurality of actuators that are respectively adapted to drive a plurality of valve elements individually using displacements of piezoelectric elements; and
a valve body that houses the plurality of actuators, wherein
a front face of the valve body includes a gas inlet port adapted to suck compressed gas into the valve body, and a plurality of gas outlet ports adapted to discharge the compressed gas that has been sucked into the valve body through the gas inlet port as the plurality of valve elements are driven to be open,
the piezoelectric valve is attachable to and detachable from a fluid device via a connector unit provided on the front face of the valve body,
the connector unit includes an inlet passage that is communicable at one end with the gas inlet port, and is communicable at another end with an air supply passage formed in the fluid device, and a plurality of discharge passages that are respectively communicable at one end with the plurality of gas outlet ports, and are respectively communicable at another end with a plurality of gas outlet passages formed in the fluid device, and
a pitch of openings of the plurality of discharge passages on the other end side is greater than a pitch of openings of the plurality of discharge passages on the one end side.

2. The piezoelectric valve according to claim 1, further comprising a valve seat plate adapted to have the plurality of actuators fixed thereto, the valve seat plate including a plurality of valve seats and a plurality of discharge passages, the plurality of valve seats being respectively adapted to be positioned in contact with and away from the plurality of valve elements individually, wherein
the plurality of actuators are housed within the valve body together with the valve seat plate, and
the compressed gas that has been sucked into the valve body through the gas inlet port is discharged from each of the plurality of gas outlet ports individually via the plurality of discharge passages of the valve seat plate as the plurality of valve elements respectively move away from the plurality of valve seats.

3. The piezoelectric valve according to claim 1, wherein
the fluid device is a manifold, and
compressed gas supplied from a compressed gas source is supplied into the valve body from the air supply passage via the inlet passage of the connector unit, and compressed gas discharged from the valve body is discharged from the plurality of gas outlet passages via the plurality of discharge passages of the connector unit.
